(19) United States
(12) Patent Application Publication
(10) Pub. No.: US 2011/0141914 A1
(43) Pub. Date: Jun. 16, 2011

(54) Systems and Methods for Providing Ethernet Service Circuit Management

(76) Inventors: Chen-Yui Yang, Marlboro, NJ (US); Carolyn V. Bekampis, Wayside, NJ (US); Wen-Jui Li, Bridgewater, NJ (US); Quangchung Yeh, Parsippany, NJ (US); Daniel A. Zuckerman, Holmdel, NJ (US)

(21) Appl. No.: 12/638,587

(22) Filed: Dec. 15, 2009

(51) Int. Cl. H04L 12/26

(52) U.S. Cl. 370/242

(57) ABSTRACT

Methods and systems for providing Ethernet service circuit management are disclosed. A system includes a network and a root cause analysis system (RCAS). Device, link, and network topologies are developed for all devices in the network and are stored at a desired data storage location. When an alarm is received by the RCAS, the RCAS retrieves the device, link, and network topologies, and performs a root cause analysis based upon the topologies and one or more rules. Depending upon the outcome of the root cause analysis, some alarms may be consolidated, suppressed, and/or reported to the appropriate network personnel.

### BACKGROUND

This application relates generally to Ethernet services. More specifically, the disclosure provided herein relates to systems and methods for providing Ethernet service circuit management.

Data networks have evolved into extremely complex and prevalent networks that handle various complex communications, instead of being relegated to merely enabling data applications. For example, data networks now handle not only data transfers, but also voice calls, for example, voice over IP (VoIP), as well as multimedia transactions such as IP television (IPTV), streaming movies on demand, streaming music and video provisioning and playback, and many other complex and useful services. With the demand for more and more bandwidth, the inability to reliably increase the size and complexity of data networks is becoming a key limitation on further expansion of carriers' data networks.

Many data network elements report errors to network operators so malfunctioning systems can be repaired. Because of the size and complexity of modern data networks, network operators spend large amounts of time and resources troubleshooting malfunctioning devices and trying to identify issues with the networks. Hundreds, thousands, and perhaps even millions of alarms or alerts may be received by a network operator, and each alarm may eventually be represented by a ticket that is put in queue for consideration by repair and/or troubleshooting personnel. Furthermore, some of these network devices are provided and/or operated by third parties and often report operational information using methods, protocols, and languages that differ from other network systems.

### SUMMARY

The present disclosure is directed to systems and methods for providing Ethernet service circuit management. A system includes a network, a root cause analysis system (RCAS), and a data storage location that resides at the RCAS, the network, or at another location in communication with RCAS. Object models for all devices and device network path models of the network are built and are stored at a storage location at or in communication with the network. During operation of the network, the network elements generate and report alarms and alerts to the network. These alarms are routed to the RCAS. The RCAS sorts and classifies the alarms and alerts and retrieves the topologies to perform the root cause analysis.

Through the established built-in design, i.e. the network topologies, and the built-in rules, which may be defined by the network operators, engineers, and/or other authorized parties, the RCAS can accomplish alarm processing with minimal delays. Because the root cause analysis is based upon rules and a scalable topology data set, the system and method described herein are fully scalable as the network grows and matures. When a device is changed or retired, the network topology data can be updated, thereby allowing root cause analysis to continue for the network.

The RCAS is configured to perform the root cause analysis to isolate service impacting problems. During the root cause analysis, multiple alarms associated with a single incident can be identified and all incident-related alarms can be correlated and redundant alarms may be suppressed and/or otherwise prevented. Thus, only meaningful root-cause alarms will be delivered, and consequently, only one actionable root cause trouble ticket may be generated. As such, the possible troubleshooting time for a particular network error may be reduced, the resolution time for a network error may be shorted, and the customer experience will therefore be improved.

According to an aspect, a computer-implemented method for providing Ethernet circuit management includes computer-implemented operations for receiving, at a network, network data. The method also includes operations for building, based upon the network data, network topology data corresponding to a network topology, and storing the network topology data at a network topology data repository. The network topology data repository includes a data storage device accessible by a root cause analysis system. The method further includes operations for receiving, at the root cause analysis system, an alarm indicating that a device of the network is malfunctioning. The method includes retrieving, from the network topology data repository, the network topology data associated with the device, and performing, at the root cause analysis system, a root cause analysis to determine a cause of the alarm.

In some embodiments, receiving the network topology data includes receiving information indicating a logical connection for the device. In some embodiments, receiving the network topology data includes receiving device topology data comprising a device model type and a device hierarchy design for the device. Receiving the information indicating a logical connection includes, in some embodiments, receiving device link topology data. The device link topology data includes a first device model corresponding to the device, a first port model corresponding to the device, a second device model corresponding to another device, and a second port model corresponding to the other device, the other device being in communication with the device.

In some embodiments, receiving the information indicating a logical connection includes receiving network communication path topology data. Receiving the network communication path topology data includes receiving data corresponding to all logical connections between the device and another device with which the device communicates.

In some embodiments, the root cause analysis includes evaluating a rule defining how to interpret the alarm and the network topology data. In some embodiments, the root cause analysis includes evaluating a rule defining how to interpret the alarm and the network topology data. The root cause analysis also can include evaluating a rule defining how to interpret the alarm and the network topology data.

In some embodiments, the method further includes operations for generating, at a ticketing module at the root cause analysis system, a ticket, and forwarding the ticket to an entity for corrective action. The method also can include operations for generating a notification, at the notification module of the root cause analysis system. The notification includes data indicating the cause. In some embodiments, the method includes operations for transmitting the notification to an entity, and communicating with a charging module to charge the entity for the notification.

According to another aspect, a system for providing Ethernet circuit management includes a memory for storing computer executable instructions. The computer executable instructions include a root cause analysis module and an alarm management module. The computer executable instructions are executable by a processor. Upon execution of the instructions by the processor make the system operative to receive an alarm, which may include a trap, the alarm or trap indicating that a device of a network is malfunctioning. The instructions are further executable to make the system operative to analyze, at the alarm management module, the alarm to determine if any alarm correlation or alarm management is appropriate. Determining that the alarm correlation or the alarm management is appropriate includes determining that the alarm relates to a problem that affects the device, or multiple devices. Execution of the instructions by the processor make the system further operative to retrieve, from a network topology data repository in communication with the system, network topology data associated with the device, and to process the data, at the root cause analysis system, to perform a root cause analysis to determine a cause of the alarm.

In some embodiments, the cause determined by the root cause analysis system includes a problem at the device, and the computer executable instructions further include a verification and testing module, the execution of which makes the system operative to test the operation of the device to determine if the device is functioning properly. In some embodiments, the system is configured to perform a second root cause analysis if the system determines that the device is functioning properly.

In some embodiments, the computer executable instructions further include a notification module. Execution of the notification module makes the system operative to generate a notification including data indicating the cause, transmit the notification to an entity, and communicate with a charging module to charge the entity for the notification.

In some embodiments, the computer executable instructions further include a ticketing module. Execution of the ticketing module makes the system operative to generate, at a ticketing module at the root cause analysis system, a ticket, and forward the ticket to an entity for corrective action. The computer executable instructions for forwarding the ticket further can include computer executable instructions, the execution of which makes the system operative to forward the ticket to a work center responsible for maintaining correct operation of the device. The computer executable instructions for forwarding the ticket further can include computer executable instructions, the execution of which makes the system operative to forward the ticket to a third party entity associated with the work center.

According to another aspect, a computer-readable medium includes computer-executable instructions, executable by a processor to provide a method for managing a network. The method includes receiving, at a network, network data, and building, based upon the network data, network topology data corresponding to a network topology. The method also includes storing the network topology data at a network topology data repository. The network topology data repository includes a data storage device accessible by a root cause analysis system. The method also includes receiving, at the root cause analysis system, an alarm indicating that a device of the network is malfunctioning, retrieving, from the network topology data repository, the network topology data associated with the device, and performing, at the root cause analysis system, a root cause analysis to determine a cause of the alarm.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 schematically illustrates a network, according to an exemplary embodiment of the present disclosure.

FIG. 2 schematically illustrates a root cause analysis system (RCAS) for providing Ethernet service circuit management, according to an exemplary embodiment of the present disclosure.

FIGS. 3A-3B schematically illustrate data structures for storing device topology data, according to exemplary embodiments of the present disclosure.

FIG. 4A schematically illustrates a data structure for storing device link topology data, according to exemplary embodiments of the present disclosure.

FIG. 4B schematically illustrates a network diagram, according to an exemplary embodiment of the present disclosure.

FIG. 4C schematically illustrates a data structure for storing device link topology data for the network topology illustrated in FIG. 4B, according to an exemplary embodiment of the present disclosure.

FIG. 5A schematically illustrates network path diagram, according to exemplary embodiments of the present disclosure.

FIG. 5B schematically illustrates a data structure for storing data relating to the network path topologies illustrated in FIG. 5A, according to an exemplary embodiment of the present disclosure.

FIG. 6 schematically illustrates a method for accessing the network management system, according to an exemplary embodiment of the present disclosure.

### DETAILED DESCRIPTION

The following detailed description is directed to methods, systems, and computer-readable media for providing Ethernet service circuit management. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

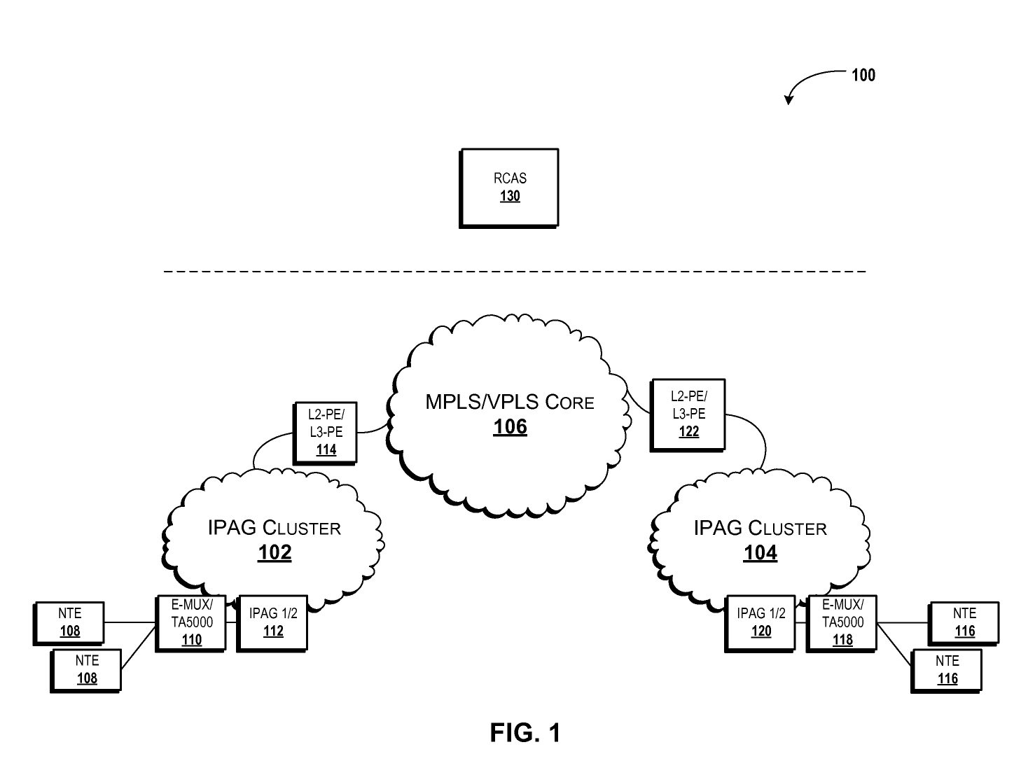

Referring now to the drawings, in which like numerals represent like elements throughout the several figures, FIG. 1 schematically illustrates a network 100, according to an exemplary embodiment of the present disclosure. The network 100 includes a first Internet Protocol Aggregator (IPAG) cluster 102 and a second IPAG cluster 104, both of which are in communication with a Multiprotocol Label Switching (MPLS)/Virtual Private Local Area Network (LAN) Service (VPLS) backbone 106 (MPLS/VPLS Core). The IPAG Clusters 102, 104 and the MPLS/VPLS Core 106 may be in communication with various additional networks and/or devices on the network 100, for example, a packet data network (PDN) such as, for example, the Internet, a publicly switched telephone network (PSTN), remote management devices, an intranet, a cellular network, other networks, and the like. The function and operation of these respective networks, network systems, and network devices are well known and will not be described in detail herein.

A network termination equipment 108 (NTE), or a number of NTE's 108, may be in communication with the IPAG cluster 102, or devices thereof, for example, an E-Mux/TA500 110 and/or Internet protocol aggregator device 112 (IPAG1/2). It will be appreciated that an Ethernet over Copper (EoCu) NTE 108 may connect to a level-1 multiplexer such as a TA5000, while an Ethernet over fiber NTE 108 is capable of connecting directly to the IPAG1 or another device. Thus, although the NTE's 108 are illustrated similarly and assigned the same reference numeral, it must be understood that the NTE's 108 may be manufactured by different vendors, may function in a manner that is substantially different from one another, and may have different reporting mechanisms, alerting mechanisms, and alarming mechanisms from other NTE's 108. Nonetheless, the NTE's 108 are well known and are therefore described generally.

The IPAG cluster 102 communicates with the MPLS/VPLS Core 106 via a layer-2 and/or layer-3 switching and/or routing device 114 (L2-PE/L3-PE). The L2-PE/L3-PE 114 may include, for example, a layer-2 switch (L2-PE) and/or a layer-3 provider edge router (L3-PE). In some embodiments, the L2-PE/L3-PE 114 includes a L2-PE that includes an uplink to the L3-PE, via which the IPAG Cluster 102, or a device connected to the IPAG Cluster 102, accesses the MPLS/VPLS Core 106. Thus, a communication may pass from the access layer, for example an NTE 108, to the distribution layer, for example an IPAG cluster 102, via the E-MUX/TA5000 110 and/or the IPAG1/2 112. The communication may then pass from the distribution layer, for example the IPAG cluster 102, to the core layer, for example the MPLS/VPLS Core 106, via the L2-PE/L3-PE 114. It will be appreciated that the illustrated network 100 is an extremely simplified representation of an Ethernet network, and that other devices may be involved in communications between the NTE 108 and the MPLS/VPLS Core 106, and/or other networks and devices.

As illustrated, one or more NTE's 116 are in communication with the second IPAG cluster 104 via an E-Mux/TA5000 118 and/or an Internet Protocol Aggregator device 120 (IPAG1/2). The IPAG cluster 104 communicates with the MPLS/VPLS Core 106 via the L2-PE/L3-PE 122 in a manner that can be substantially similar to that described above with respect to the first IPAG cluster 102. While the illustrated network 100 shows two IPAG clusters 102, 104, it should be understood that more than two IPAG clusters may be included in the network 100. The illustrated configuration, i.e., two IPAG clusters 102, 104, is illustrated solely for the sake of clarifying the description, and should not be construed as being limiting in any way.

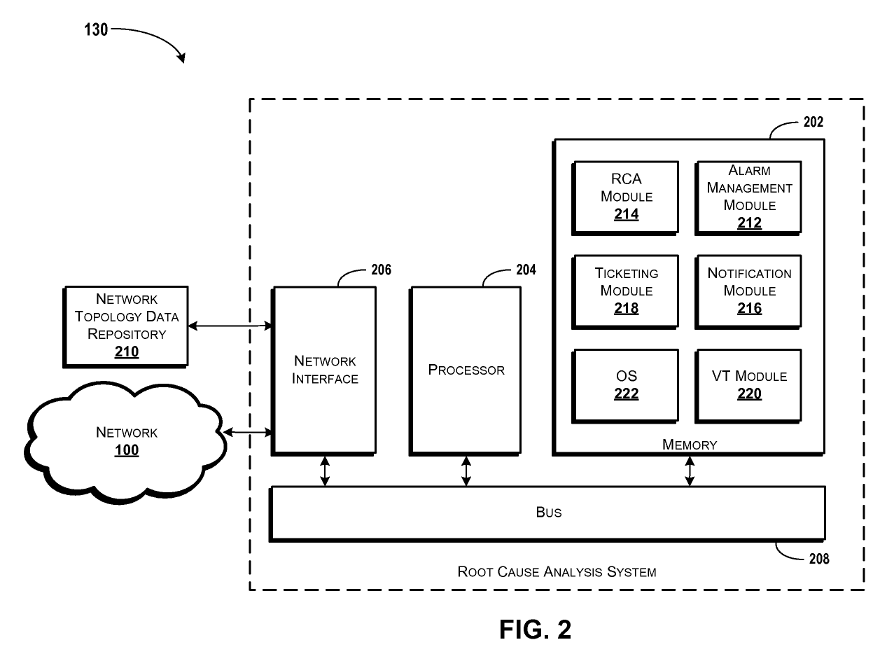

One or more elements of the network 100 communicate with a root cause analysis system 130 (RCAS), either directly or indirectly via intermediate reporting mechanisms such as alarming, alerting, reporting, Internet control message protocol (ICMP) messaging, combinations thereof, and the like. For example, the IPAG Clusters 102, 104, the MPLS/VPLS Core 106, the NTE's 108, 116, the E-MUX/TA5000 110, 118, the IPAG1/2 devices 112, 120, and the L2-PE/L3-PE's 114, 122, as well as other devices including network devices that are not shown or described, can communicate directly and/or indirectly with the RCAS 130 and/or can generate reports, alarms, alerts, and the like, that are received by the RCAS 130 directly or indirectly, for example via other networks, network elements, nodes, systems, subsystems, components, and the like. The RCAS 130 is configured to receive data, e.g., alarms, alerts, operational information, status updates, and/or other information, from one or more elements of the network 100, and to interpret these data to identify problems and/or issues with the network 100. These and other functions of the RCAS 106 will be described in more detail below with reference to FIGS. 2-6.

FIG. 2 schematically illustrates the RCAS 130, according to an exemplary embodiment of the present disclosure. The illustrated RCAS 130 includes a memory 202, a processing unit 204 (“processor”), and a network interface 206, each of which is operatively connected to a system bus 208 that enables bi-directional communication between the memory 202, the processor 204, and the network interface 206. Although the memory 202, the processor 204, and the network interface 206 are illustrated as unitary devices, some embodiments of the RCAS 130 include multiple processors, multiple memory devices, and/or multiple network interfaces.

The processor 204 may be a standard central processor that performs arithmetic and logical operations, a more specific purpose programmable logic controller (“PLC”), a programmable gate array, or other type of processor known to those skilled in the art and suitable for controlling the operation of the RCAS 130. Processors are well-known in the art, and therefore are not described in further detail herein.

Although the memory 202 is illustrated as communicating with the processor 204 via the system bus 208, in some embodiments, the memory 202 is operatively connected to a memory controller (not shown) that enables communication with the processor 204 via the system bus 208. Furthermore, although the memory 202 is illustrated as residing at the RCAS 130, it should be understood that the memory 202 may include a remote data storage device accessed by the RCAS 130, for example a network topology data repository 210 (NTDR). Therefore, it should be understood that the illustrated memory 202 can include one or more databases or other data storage devices communicatively linked with the RCAS 130.

The network interface 206 enables the RCAS 130 to communicate with other networks or remote systems, for example, the network 100 and/or the NTDR 210. Examples of the network interface 206 include, but are not limited to, a modem, a radio frequency (“RF”) or infrared (“IR”) transceiver, a telephonic interface, a bridge, a router, and a network card. Thus, the RCAS 130 is able to communicate with the network 100 and/or various components of the network 100 such as, for example, a Wireless Local Area Network (“WLAN”) such as a WIFI® network, a Wireless Wide Area Network (“WWAN”), a Wireless Personal Area Network (“WPAN”) such as a BLUETOOTH® device, a Wireless Metropolitan Area Network (“WMAN”) such as a WIMAX® network, and/or a cellular network. Additionally or alternatively, the RCAS 130 is able to access a wired network including, but not limited to, a Wide Area Network (“WAN”) such as the Internet, a Local Area Network (“LAN”) such as an intranet, and/or a wired Personal Area Network (“PAN”), or a wired Metropolitan Area Network (“MAN”). The RCAS 130 also may access a PSTN. As mentioned above, the RCAS 130 is configured to receive data from one or more elements of the network 100. The RCAS 130 may receive these data via the network interface 206.

As illustrated, the memory 202 is configured for storing computer executable instructions that are executable by the processor 204 to make the RCAS 130 operative to provide the functions described herein. While embodiments will be described in the general context of program modules that execute in conjunction with application programs that run on an operating system on the RCAS 130, those skilled in the art will recognize that the embodiments may also be implemented in combination with other program modules. For purposes of clarifying the disclosure, the instructions are described as a number of program modules. It must be understood that the division of computer executable instructions into the illustrated and described program modules may be conceptual only, and is done solely for the sake of conveniently illustrating and describing the RCAS 130. In some embodiments, the memory 202 stores all of the computer executable instructions as a single program module. In some embodiments, the memory 202 stores part of the computer executable instructions, and another system and/or data storage device stores other computer executable instructions. As such, it should be understood that the RCAS 130 may be embodied in a unitary device, or may function as a distributed computing system wherein more than one hardware and/or software modules provide the various functions described herein.

For purposes of this description, “program modules” include applications, routines, programs, components, software, software modules, data structures, and/or other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. The embodiments may also be practiced in distributed computing environments where tasks are performed by remote processing devices that are linked through a communications network. In a distributed computing environment, program modules may be located in both local and remote memory storage devices.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the RCAS 130.

As illustrated, the RCAS 130 includes an alarm management module 212. The alarm management module 212 is executable by the processor 204 to provide initial alarm gathering and sorting functionality for the RCAS 130. As mentioned above, the network 100 may be divided into a number of systems, subsystems, components, networks, combinations thereof, and the like. Similarly, as mentioned above, some or all of the software and/or hardware modules of the network 100, or elements of the network 100, may be provided, operated, and/or managed by different individuals, entities, teams, and/or organizations within a network management organization. In some implementations of the network 100, third parties operate some or all of the network elements and/or systems. Many, if not all, of these network elements may have a reporting function associated therewith. The alarm management module 212 is operative to receive these alarms and perform initial analyzing functions for these alarms to determine if any correlation or management is appropriate. As will be explained below, some alarms may be correlated, suppressed, and/or otherwise managed using root cause analysis for the alarms. Some alarms will not pass through the root cause analysis. For example, these alarms are independent, by nature, and they don't have any correlation with any other alarms; or these alarms may be associated with network elements that require little analysis; or may be associated with network elements managed by other entities. In either or additional cases, no further analysis may be performed on the alarms for the sake of preserving network and/or RCAS 130 resources. These alarms may be sorted out and forwarded to other modules of the RCAS 130, or may be disposed of by the RCAS 130.

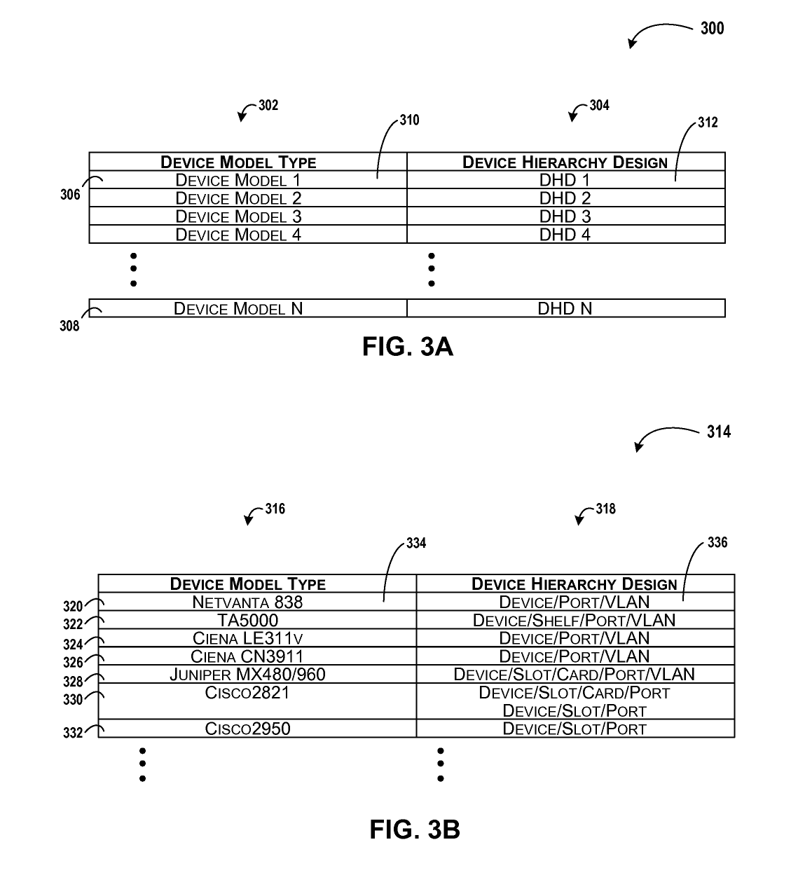

The RCAS 130 also includes a root cause analysis (RCA) module 214. The RCA module 214 is configured to receive alarms, alerts, and/or other information from the network 100, and to analyze and determine a root cause for the alarms, alerts, and/or other information. The functions of the RCA module 214, and how the RCA module 214 performs the root cause analysis, will be described in detail below with reference to FIGS. 3-6.

The RCAS 130 also includes a notification module 216. As mentioned above, the some of the network elements are provided, operated, and/or managed by third party entities, e.g., third party vendors. In some embodiments, the notification module 216 is used to provide the third party vendors, and/or other entities, with notifications that relate to the performance of network elements provided and/or operated by entities other than the network operator. Thus, the entities may receive operational information to help them improve their products and/or services. In some embodiments the notification module 216 sends notifications to these entities, or operates as a server to provide the notifications to these entities upon request or query for notification information. The functionality of the notification module 216 may be provided for free, or may be provided as an “opt-in” service for a fee paid to the network operator or another entity. Thus, the notification module 216 may interface with billing and/or charging systems or modules of the network 100, or may store billing or charging information at the memory 202 or an external data storage device such as a server or database.

The RCAS 130 also includes a ticketing module 218. In some embodiments, the RCA module 214 sends a record of each determined alert, alarm, and/or other information to the ticketing module 218 for determining if any entity should receive notice of the alarm, alert, and/or other information. The ticketing module 218 module is configured to generate and transmit tickets to an appropriate work center of the network 100. As mentioned above, elements of the network 100 may be provided, administered, and/or managed by different entities. Thus, the ticketing module 218 is configured to determine a work center associated with an alarm and/or to correlate a determined alarm, alert, and/or other information with a work center or other responsible party for any particular identified root cause. The ticket may be used by the receiving entity, e.g., a work center, to prompt corrective action steps. It should be understood that the ticketing module 218 may send a ticket to a work center or other entity before or after root cause analysis for the alarm/alert is completed. In other words, the ticketing module 218 is configured to route alarms, alerts, and/or other data to the appropriate party for corrective action, ticket generation, notification purposes, or for other operations.

The RCAS 130 also includes a verification and testing module 220 (VTM). For purposes of this specification, a or the “root cause” may refer to a device, devices, a link, links, a port, ports, a communication path, or the like, that is identified as causing a received alarm. The VTM 220 is configured to verify and test the root cause suggested by the RCA module 214. More particularly, the root cause output by the RCA module 214 may or may not be the actual root cause. In other words, the proposed root cause identified by the RCA module 214 may be tested to determine a likelihood that the proposed root cause is the actual root cause. To verify that the determined root cause is possible and/or probable, the VTM 220 is configured to access the proposed root cause for testing and/or verification. Thus, the VTM 220 accesses or tests the proposed root cause to see if the proposed root cause is consistent with current operating or response characteristics of the proposed root cause. For example, if the RCA module 214 identifies an NTE 108 as being the proposed root cause for a connection error, the VTM 220 may be configured to access the NTE 108 and to conduct a test program with the NTE 108 to determine if the NTE 108 is responding in a manner consistent with healthy operation of the NTE 108. If the NTE 108 responds to the test or completes a test program successfully, the VTM 220 may determine that the proposed root cause is not correct. In such a case, the RCAS 130 is configured to reanalyze the alarm and/or alert information to again determine the root cause. If the VTM 220 determines that the proposed root cause is possible and/or probable, the VTM 220 can pass a notification to the notification module 216, the ticketing module 218, and/or other modules or hardware for additional or alternative action.

In some embodiments, the VTM 220 employs a test strategy to verify the root cause proposed by the RCA module 214. In a first exemplary testing strategy, the VTM 220 performs an Ethernet OAM test in which the VTM 220 performs connectivity testing to debug the Ethernet network from end-to-end. The connectivity testing includes, for example, a continuity check, a link trace, and loopback protocols (802.1ag), which are performed per service/VLAN. In a second exemplary testing strategy, the VTM 220 performs a pseudowire test. The VTM 220 performs ping tests between network elements, for example from L2PE to L2PE and/or IPAG to IPAG to verify the MPLS path between the tested elements. In a third exemplary testing strategy, the VTM 220 performs a VPLS ping test, wherein the VTM 220 verifies the VPLS path between network elements such as, for example, a VPLS-PE/IPAG of a first IPAG cluster and a VPLS-PE/IPAG of a second IPAG cluster. These testing strategies are merely exemplary and should not be construed as being limiting in any way.

In some embodiments, the memory 202 includes an operating system 222. Examples of operating systems include, but are not limited to, WINDOWS, WINDOWS CE, and WINDOWS MOBILE from MICROSOFT CORPORATION, LINUX, SYMBIAN from SYMBIAN LIMITED, BREW from QUALCOMM CORPORATION, MAC OS from APPLE CORPORATION, and FREEBSD operating system. The memory 202 also is configured to store other information (not illustrated). The other information may include, but is not limited to, data storage for the RCAS 130, computer readable instructions corresponding to additional program modules, RCAS 130 operating statistics, billing and/or charging modules, data caches, data buffers, authentication data, combinations thereof, and the like.

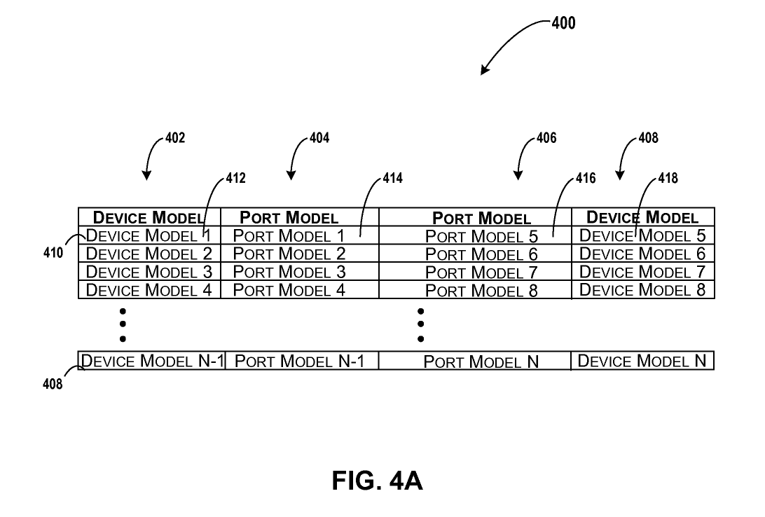

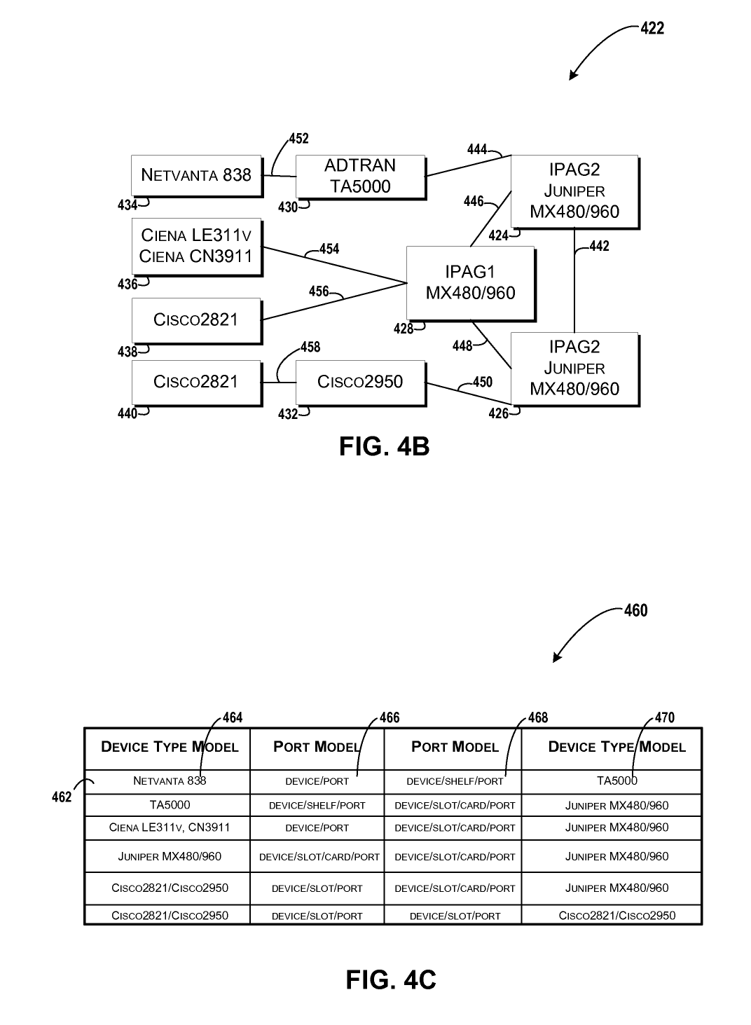

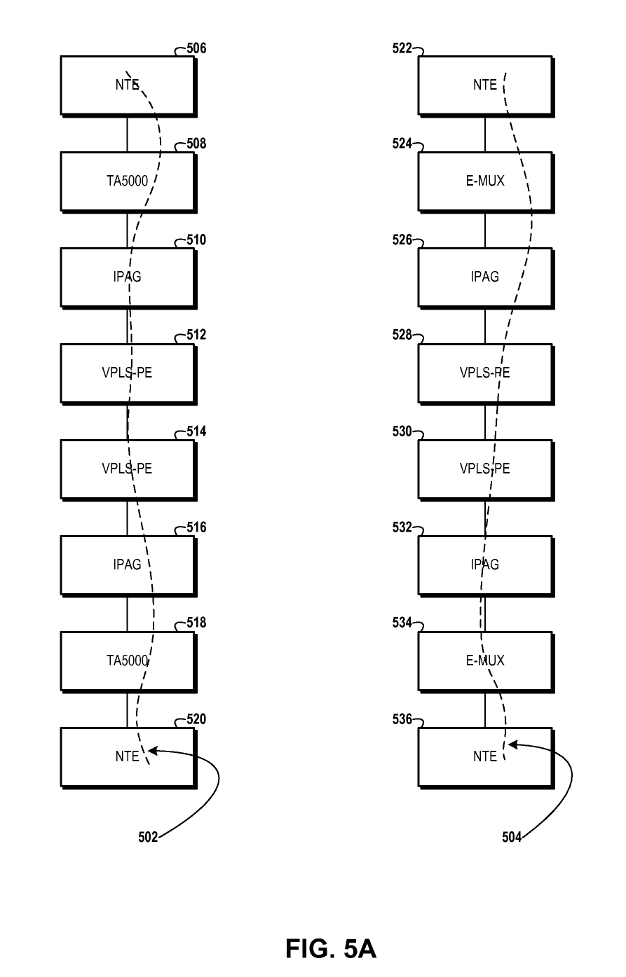

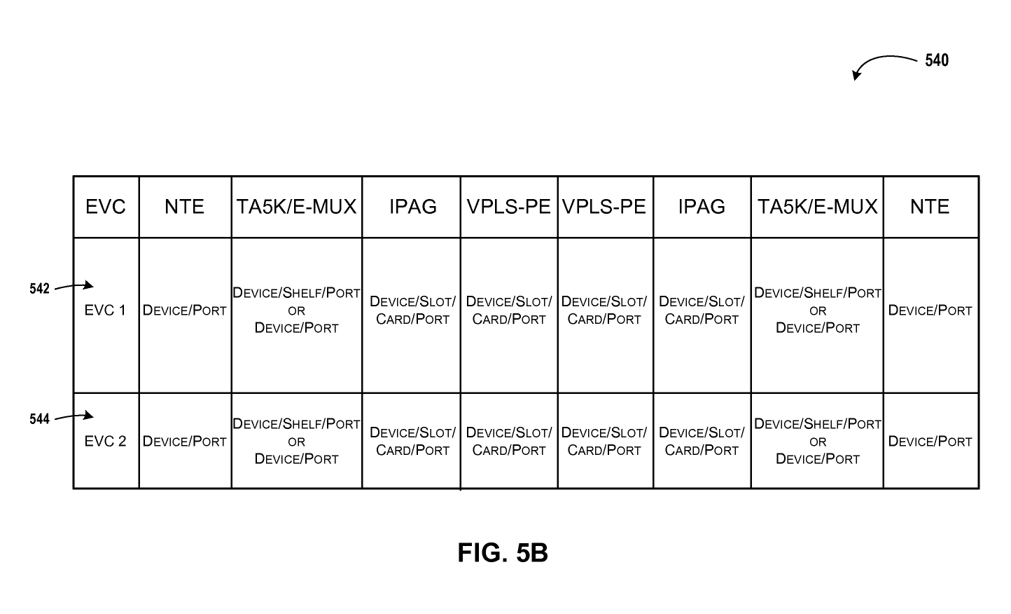

FIG. 3A schematically illustrates a data structure 300, according to an exemplary embodiment of the present disclosure. The data structure 300 stores device topology data for devices operating on the network 100. The data structure 300 can be stored at the NTDR 210, the memory 202 of the RCAS 130, and/or another data storage device. In some embodiments, the data structure 300 stored at the NTDR 210 is retrieved by the RCAS 130 according to a schedule, when an alarm or alert is received at the RCAS 130, or when the data structure 300 is needed to perform a root cause analysis, e.g., in response to a command to perform a root cause analysis. The data structure 300 is illustrated as storing data organized by a device model type column 302 and a device hierarchy design column 304, though it should be understood that this organization is merely exemplary and is provided solely for the sake of more clearly describing various concepts of the present disclosure. In some embodiments of the present disclosure, the data is stored in an alternative structure such as a tree-type object-oriented database. Similarly, the data structures illustrated in FIGS. 4A-4B, 5A, and 5C are merely exemplary and should not be construed as being limiting in any way.

The illustrated data structure 300 stores N records, beginning with a first record 306 and continuing through an Nth record 308. The illustrated first record 306 includes a device model 310, illustrated as “Device Model 1,” and a device hierarchy design 312 (DHD), illustrated as “DHD 1.” The illustrated data structure 300 reflects devices for various vendors and/or devices employed for use in the network 100 for different purposes and/or technologies. The data structure 300 is modeled using the same logical rule set. The logical rule set can include, but is not limited to, the device, shelf, slot, card, port entries, and/or other data.

It should be understood that while the devices of the network 100 may be modeled using the “same logical rule set,” the devices are not necessarily reflected in the data structure 300 as being modeled using the same method, since various devices, manufactures, and even models may use different methods of dividing logical connections within a particular device. For example, some CISCO® switches may have a card while other CISCO® switches do not have a card. In the case of CISCO® switches, in fact, even the same device models may use different methods of dividing logical connections. Similarly, some JUNIPER® devices have a card, while CIENA® and/or ADTRAN® devices do not. On the other hand, there sometimes exists some commonality among devices, even from different vendors. For example, CIENA® and ADTRAN® NTE's have the same method, namely, device and ports. These examples are merely exemplary and are provided to illustrated the concepts discussed above. Thus, these examples should not be construed as limiting in any way.

Each device entity, shelf, slot, card, or report, has a corresponding attribute or attributes associated therewith. By employing a port access identifier (AID) attribute in the port record, the RCAS 130 is able to identify which higher level port, slot, and/or card, with which the port is associated. These data are used to build a device topology for the network 100, and the device topology is built using the same rule set. Furthermore, the data structure 300 may be used to reveal what kind of link each port has, i.e., whether the device is a link from a customer's equipment, a link to an upper network layer, or the like. Based, at least partially, upon this logic and/or discovery, the software can tag each port properly for its future port alarm processing. In other words, by determining the topology of any device on the network 100, a received alarm can be reviewed to determine a device, a shelf, a card, a slot, and/or even a VLAN with which the alarm is related, thereby greatly simplifying alarm/alert analysis. In some embodiments this device hierarchy topology is built before any alarms are received.

Referring now to FIG. 3B, a data structure 314 is illustrated, according to another exemplary embodiment of the present disclosure. The exemplary data structure 314 in structured similarly to the data structure 300 of FIG. 3A. As illustrated, the data structure 314 includes a device model type column 316 and a device hierarchy design (DHD) column 318. The data structure 314 includes exemplary data records 320, 322, 324, 326, 328, 330, 332. For example, the data record 320 includes a device model type field 334, illustrated as “Netvanta 383,” and a DHD field 336, illustrated as “Device/Port/VLAN.” It should be understood that the data illustrated in the exemplary data structure 314 is exemplary only, and should not be construed as limiting in any way.

Turning now to FIG. 4A, a data structure 400 is illustrated, according to another exemplary embodiment of the present disclosure. The exemplary data structure 400 is used to store network topology for one or more device links in the network 100. The illustrated data structure 400 includes a first device model column 402, a first port model column 404, a second port model column 406, and a second device model column 408. For an exemplary record 410, the first device model field 412 is illustrated as “Device Model 1,” the first port model field 414 is illustrated as “Port Model 1,” the second port model 416 is illustrated as “Port Model 5,” and the second device model field 418 is illustrated as “Device Model 5.” It should be understood that these data are exemplary only, and should not be construed as being limiting in any way. The data structure 400 stores N records, illustrated in FIG. 4A as beginning with a first record 410, and ending with an Nth record 420. With an understanding of FIG. 4A, the network connection topology illustrated in FIGS. 4B and 4C will be more easily understood.

Turning now to FIG. 4B, a portion 422 of a network, network topology, or network topology instance (“network portion”) is illustrated, according to an exemplary embodiment of the present disclosure. The network portion 422 illustrated in FIG. 4B is illustrative only and should not be construed as limiting in any way. The illustrated network portion 422 includes various exemplary network elements 424, 426, 428, 430, 432, 434, 436, 438, 440. As illustrated in FIG. 4B, links 442, 444, 446, 448, 450, 452, 454, 456, 458 exist between some of the network elements 424, 426, 428, 430, 432, 434, 436, 438, 440, more particularly, between network elements that are linked one to the other to assist in providing data transmission for the network 100. The data stored in the data structures 300, 400 may be combined to provide a device model and port model for any link in the network 100. Furthermore, by analyzing data reflected in the data structures 300, 400, the RCAS 130 is able to understand the logical connections between two or more elements of the network 100, and can search for and determine a root cause for a received alarm, alert, or other information.

Turning now to FIG. 4C, a data structure 460 is illustrated, according to an exemplary embodiment of the present disclosure. The data structure 460 is structured in a manner quite similar to the data structure 400 illustrated in FIG. 4A, so the format of the data structure 460 will not be described in detail herein. The data structure 460 stores data reflecting the network portion 422 illustrated in FIG. 4B. Thus, it will be understood that the data stored in the data structure 460 includes network topology data for a link between at least two devices operating on the network 100. For example, as illustrated in FIG. 4C, the link 452 between network elements 430 and 434 may be represented by the data record 462, which includes the device name 464 for the network element 434, the port model 466 for the network element 434, the port model 468 for the network element 430, and the device type model 470 for the network element 432. It should be understood that the data reflected in the data structure 460 is merely exemplary, and should not be construed as limiting in any way.

It should be understood that a data structure, e.g., the data structure 460, can reflect a network topology for the network 100 and/or other networks, and may be generated and stored at a data storage device of the network 100, for example, the NTDR 210. In some embodiments, the network topology data structure is built and stored at a data storage location before any alarms are received over the network 100. In some embodiments, the network topology data structure is built during normal operation of the network 100. This is matter of preference for the network operator. Additionally, one or more network topology data structures may be used in conjunction with a network path topology data structure to further aid in alarm and alert root cause analysis.

Turning now to FIG. 5A, two exemplary network path diagrams 502, 504 are schematically illustrated, according to an exemplary embodiment of the present disclosure. The network path diagram 502 includes a communication path that passes through the network elements 506, 508, 510, 512, 514, 516, 518, 520. The network path diagram 504 includes a communication path that passes through the network elements 522, 524, 526, 528, 530, 532, 534, 536. It should be understood that these network path diagrams 502, 504, and the illustrated network elements 506-536, are merely exemplary, and should not be construed as limiting in any way.

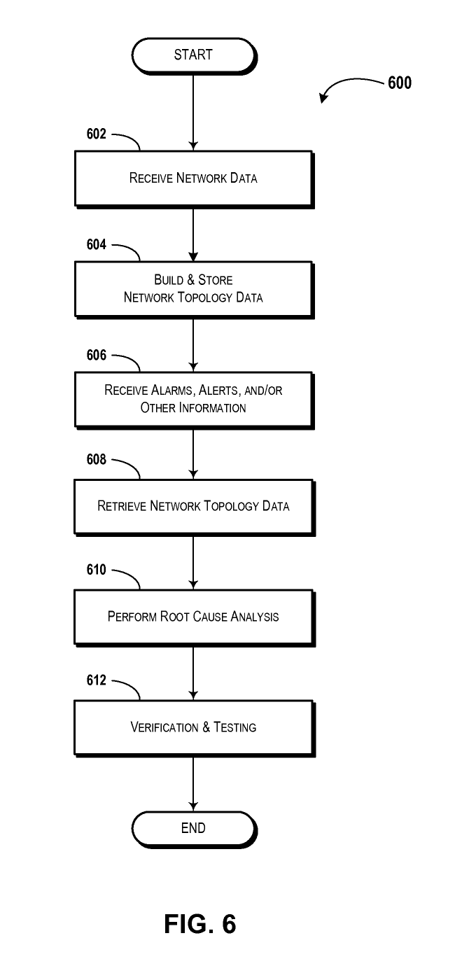

Referring now to FIG. 5B, a data structure 540 is illustrated, according to an exemplary embodiment of the present disclosure. It will be appreciated by referring to FIGS. 5A and 5B, that the first data record 542 of FIG. 5B includes data that describes a network topology instance corresponding to the network path diagram 502 of FIG. 5A. Similarly, it will be appreciated that the second data record 544 of FIG. 5B includes data that describes a network topology instance corresponding to the network path diagram 504 of FIG. 5A. In other words, a network topology instance corresponding to the network path diagram 502 is reflected by the Ethernet Virtual Circuit (EVC) 1, represented by the data record 542, and a network topology instance corresponding to the network path diagram 504 is reflected by EVC 2, represented by the data record 544. Any communication path, network topology instance, and/or network path topology in a network 100 can be described in a method similar to the data records 542, 544 shown in FIG. 5B. It will be appreciated that the data shown in FIG. 5B may be built based upon, or incorporating, the data described above with reference to FIGS. 3A-5A, and may be stored at a network data storage device such as, for example, the memory 202 of the RCAS 130, the NTDR 210, and/or another data storage location. Data reflecting a network path topology or network topology instances, for example, the network path diagrams 502, 504, are used by the RCAS 130 to perform root cause analysis functions of the RCAS 130, as will be explained below with reference to FIG. 6.

FIG. 6 illustrates a method 600 for determining a root cause for an alarm or alert received at a network device, according to an exemplary embodiment of the present disclosure. It should be understood that the operations of the method 600 are not necessarily presented in any particular order and that performance of some or all of the operations in an alternative order(s) is possible and is contemplated. The operations have been presented in the demonstrated order for ease of description and illustration. Operations may be added, omitted and/or performed simultaneously, without departing from the scope of the appended claims. It also should be understood that the illustrated method 600 can be ended at any time and need not be performed in its entirety.

Some or all operations of the method 600, and/or substantially equivalent operations, can be performed by execution of computer-readable instructions included on a computer-storage media, as defined above. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts, and modules may be implemented in software, in firmware, in special purpose digital logic, and any combination thereof.

The method 600 begins at operation 602, wherein an element of the network 100, for example the NTDR 210 or the RCAS 130, receives network data, for example, network path data or data indicating one or more network topology instances. It should be appreciated that the network data received by the element of the network 100 may include data relating to numerous network path topology instances. In some embodiments, the element of the network 100 stores thousands of network path topology instances. The network path topology instances may be created by network personnel and submitted to a network element for storage by the element of the network 100, though this is not necessarily the case.

The method 600 proceeds to operation 604, wherein the network 100, or an element thereof such as, for example, the RCAS 130 builds and stores a network topology instance based upon the network data. The building of the network topology instances is explained in detail above, particularly with reference to FIGS. 3-6. The network topology instance, or multiple network topology instances, are stored at one or more data storage devices such as, for example, the NTDR 210, the memory 202, a database in communication with the RCAS 130, or other data storage devices.

The method 600 proceeds to operation 606, wherein the network 100, or an element thereof such as, for example, the RCAS 130, receives one or more alarms, alerts, and/or other information. In some embodiments, the RCAS 130 executes one or more program modules stored in the memory 202 to obtain the alarms, alerts, and/or other information, and in some embodiments, the RCAS 130 receives alarms, alerts, and/or other information from the appropriate network systems. It should be understood that in some networks, hundreds, thousands, or even millions of alarms may be received during a day, week, month, or year. Thus, the RCAS 130, or a module thereof such as the alarm management module 212 may sort the alarms and suppress and/or dispose of alarms that do not need to be reported or ticketed. The sorting, ticketing, and/or notifications of alarms are discussed above with reference to FIG. 2.

The method proceeds to operation 608, wherein the RCAS 130 retrieves the network topology data from a storage location accessible by the RCAS 130. In some embodiments, the storage location includes the memory 202 of the RCAS 130, and in some embodiments, the data storage location includes a database or server, for example, the NTDR 210. The network topologies, and the data stored as the network topologies, are discussed above with reference to FIGS. 3A through 5B.

The method 600 proceeds to operation 610, wherein the RCAS 130, or a module thereof such as, for example, the RCA module 214, performs a root cause analysis for an alarm, alert, and/or other information. The RCAS 130 uses the network topology data to correlate and/or suppress one or more alarms, alerts, and/or other information. Examples of root cause analysis are provided below. The method 600 proceeds to block 612, wherein the RCAS 130 performs verification and testing of the proposed root cause. In some embodiments, the RCAS 130 uses the VTM 220 to verify and test the proposed root cause. After the RCAS 130 verifies and tests and proposed root cause, the RCAS 130 determines the next system activity, for example, involving the notification module 216 and/or the ticketing module 218. The method 600 ends.

It should be understood that a network path topology may be used to troubleshoot and manage a network, and that network elements such as, for example, the RCAS 130, may use the network path topologies during root cause analysis of received alarms, alerts, and/or other information. Additionally, it should be understood that rules may be defined by an entity, for example, a network operator, engineering personnel, and the like. Thus, in some embodiments, the RCAS 130 stores or accesses thousands of root cause analysis rules during performance of the root cause analysis. The following examples are exemplary only, and are provided to further illustrate the concepts set forth above. These examples should not be construed as limiting in any way.

In a first non-limiting example, two adjacent equipment alarms are received by the RCAS 130. In this example, a rule is defined for the particular devices involved, and the rule is interpreted by the RCAS 130 to determine that the alarms are not related. This determination could be made in a number of ways, for example, by determining that the adjacent devices do not communicate with one another, or that the conditions for which the alarms have been received would have no impact on traffic. For example, some equipment alarms, like the JUNIPER® field replace unit (FRU) alarm, or TA's chassis alarm, do not have any immediate impact on customer network traffic. Thus, these alarms are associated with a device or chassis, and not a link or network path. Thus, these alarms do not have a common cause and should not be correlated or suppressed. At any rate, upon making this determination, regardless of how this determination is made, the RCAS 130 determines that the alarms are not related and the ticketing module 218 opens a ticket for each of the network elements involved, and forwards the ticket to the appropriate recipient for action.

In a second non-limiting example, two adjacent devices with a common link begin generating alarms that are received by the RCAS 130. The RCAS 130 performs the root cause analysis, as discussed above, and determines that the alarms are related because the devices generating the alarms are adjacent and share a common link. For example, if a link between an IPAG1, e.g., a JUNIPER® MX480, and an NTE, e.g., a CIENA® LE311v, is broken, the RCAS 130 may receive a JUNIPER® “linkDown” alarm from the IPAG1 identifying the slot/card/port information from the trap data. Using this information, the RCAS 130 identifies the remote-end of this port, in this case a link at the CIENA® NTE. When the RCAS 130 receives a CIENA® NTE “linkDown” alarm, the RCAS 130 matches the determined remote-end information determined from the JUNIPER® alarm and determines that the CIENA® alarm is merely responding to the link failure. Thus, the RCAS 130 determines that alarms are related and creates only one ticket relating to this incident. Thus, the RCAS 130 is operative to consolidate multiple alarms from multiple devices into a single alarm that pinpoints a link, device, connection, path, or the like. The RCAS 130 generates a ticket and sends the ticket to the appropriate recipient for action.

In a third non-limiting example, two adjacent devices with an 802.1ag correlation begin generating alarms that are received by the RCAS 130. In an 802.1ag configuration, the EVC paths are checked end-to-end. When this approach of OAM checking fails, the RCAS 130, or another element of the network, receives NTE CFM alarms. Based upon the EVC path topology, the link failures may be correlated and only one alarm may be reported. For example, the RCAS 130 performs the root cause analysis, as discussed above, and determines that the alarms are related because the devices generating the alarms are adjacent and have a CFM correlation. Thus, the RCAS 130 is operative to suppress all further CFM alarms caused by the link in question, and opens one trouble ticket for the devices involved. The RCAS 130 generates a ticket and sends the ticket to the appropriate recipient for action.

Although the subject matter presented herein has been described in conjunction with one or more particular embodiments and implementations, it is to be understood that the embodiments defined in the appended claims are not necessarily limited to the specific structure, configuration, or functionality described herein. Rather, the specific structure, configuration, and functionality are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the embodiments, which is set forth in the following claims.

We claim:

1. A computer-implemented method for providing Ethernet circuit management, the method comprising computer-implemented operations for:
receiving, at a network, network data;
building, based upon the network data, network topology data corresponding to a network topology;
storing the network topology data at a network topology data repository, the network topology data repository comprising a data storage device accessible by a root cause analysis system;
receiving, at the root cause analysis system, an alarm indicating that a device of the network is malfunctioning;
retrieving, from the network topology data repository, the network topology data associated with the device; and
performing, at the root cause analysis system, a root cause analysis to determine a cause of the alarm.

2. The method of claim 1, wherein receiving the network data comprises receiving information indicating a logical connection for the device.

3. The method of claim 1, wherein receiving the network data comprises receiving device topology data comprising a device model type and a device hierarchy design for the device.

4. The method of claim 2, wherein receiving the information indicating a logical connection comprises receiving device link topology data.

5. The method of claim 4, wherein receiving the device link topology data comprises receiving data that includes:
a first device model corresponding to the device;
a first port model corresponding to the device;
a second device model corresponding to another device; and
a second port model corresponding to the other device, the other device being in communication with the device.

6. The method of claim 2, wherein receiving the information indicating the logical connection comprises receiving network communication path topology data.

7. The method of claim 6, wherein receiving the network communication path topology data comprises receiving data corresponding to all logical connections between the device and another device with which the device communicates.

8. The method of claim 3, wherein the root cause analysis comprises evaluating a rule defining how to interpret the alarm and the network topology data.

9. The method of claim 5, wherein the root cause analysis comprises evaluating a rule defining how to interpret the alarm and the network topology data.

10. The method of claim 7, wherein the root cause analysis comprises evaluating a rule defining how to interpret the alarm and the network topology data.

11. The method of claim 1, further comprising:
generating, at a ticketing module at the root cause analysis system, a ticket; and
forwarding the ticket to an entity for corrective action.

12. The method of claim 1, further comprising:
generating a notification, at the notification module of the root cause analysis system, the notification comprising data indicating the cause;
transmitting the notification to an entity; and
communicating with a charging module to charge the entity for the notification.

13. A system for providing Ethernet circuit management, the system comprising:
a memory for storing computer executable instructions, the computer executable instructions comprising a root cause analysis module and an alarm management module, the computer executable instructions being executable by a processor, wherein execution of the instructions by the processor make the system operative to:
receive an alarm indicating that a device of a network is malfunctioning;
analyze, at the alarm management module, the alarm to determine if any alarm correlation or alarm management is appropriate, wherein determining that the alarm correlation or the alarm management is appropriate comprises determining that the alarm relates to a problem that affects the device and another device;
retrieve, from a network topology data repository in communication with the system, network topology data associated with the device; and
perform, at the root cause analysis system, a root cause analysis to determine a cause of the alarm.

14. The system of claim 13, wherein:
the cause determined by the root cause analysis system comprises a problem at the device; and
the computer executable instructions further comprise a verification and testing module, the execution of which makes the system operative to test the operation of the device to determine if the device is functioning properly.

15. The system of claim 13, wherein the system is configured to perform a second root cause analysis if the system determines that the device is functioning properly.

16. The system of claim 13, wherein the computer executable instructions further comprise a notification module, the execution of which makes the system operative to:
generate a notification comprising data indicating the cause;
transmit the notification to an entity; and
communicate with a charging module to charge the entity for the notification.

17. The system of claim 13, wherein the computer executable instructions further comprise a ticketing module, the execution of which makes the system operative to:
generate, at a ticketing module at the root cause analysis system, a ticket; and
forward the ticket to an entity for corrective action.

18. The system of claim 17, wherein the computer executable instructions for forwarding the ticket comprise computer executable instructions, the execution of which makes the system operative to forward the ticket to a work center responsible for maintaining correct operation of the device.

19. The system of claim 18, wherein the computer executable instructions for forwarding the ticket further comprise computer executable instructions, the execution of which makes the system operative to forward the ticket to a third party entity associated with the work center.

20. A computer-readable medium comprising computer-executable instructions, executable by a processor to provide a method for managing a network, the method comprising:
receiving, at a network, network data;
building, based upon the network data, network topology data corresponding to a network topology;
storing the network topology data at a network topology data repository, the network topology data repository comprising a data storage device accessible by a root cause analysis system;
receiving, at the root cause analysis system, an alarm indicating that a device of the network is malfunctioning;
retrieving, from the network topology data repository, the network topology data associated with the device; and
performing, at the root cause analysis system, a root cause analysis to determine a cause of the alarm.
